(19) United States
(12) Patent Application Publication
(10) Pub. No.: US 2006/0150220 A1
(43) Pub. Date: Jul. 6, 2006

(54) Computer based entertainment center

(76) Inventor: Demian Martin, San Leandro, CA (US)

Correspondence Address: LaRiviere, Grubman & Payne, LLP, P.O. Box 3140, Monterey, CA, 93942, US

(21) Appl. No.: 11/029,031

(22) Filed: Jan. 3, 2005

(51) Int. Cl. H04N 7/18; H04N 7/173

(52) U.S. Cl. 725/81; 725/100; 725/131

(57) ABSTRACT

A novel computer based audio/visual home entertainment center based on improved computer 101 and enhanced audio/video receiver 201 is disclosed herein.

### TECHNICAL FIELD

The present invention relates to audio/video system. More particularly, the present invention relates to enhancing audio/video systems designed to optimize and simplify the user's media playback experience. Even more particularly, the present invention relates to an enhanced and integrated combination of home theater receiver and home computer functionality into an improved system and device.

### BACKGROUND ART

Traditional home theater systems operate independently from home computer systems. Operation of the home theater receiver is a straightforward pushbutton procedure which often occurs without user feedback or substantial subsequent interaction. Even when computer enthusiasts incorporate aftermarket products to integrate the home computer and home theater devices, the result is often an awkward step backward in terms of ease of operation and user enjoyment.

The benefits of joining home computer technology with home theater functionality are compelling. Home computers can store vast music libraries which would be impractical or inconvenient to access if kept in a traditional CD music library but lack suitable playback capabilities as most home computers often have limited speaker output capacity. Home computer speakers are notoriously low powered and of limited quality. Conversely, home audio/video receivers provide substantially better quality sound output, but often do not have a sophisticated memory or content retrieval system. Output capabilities of even mid-range home theater receivers offer substantially better sound reproduction as well as multiple channel output, and even offer multiple room output as well. Consequently, there has been a long felt need for an optimized union of the two devices into an enhanced entertainment system drawing off the strengths of both while limiting the drawbacks of each.

### DISCLOSURE OF THE INVENTION

By specifically adapting the audio/video receiver to obtain digital content from the paired home computer, entertainment options are substantially expanded. To do so, however, the electronically ‘noisy’ environment of the home computer must be shielded from the improved a/v receiver. Digital data needs to be passed from the computer to the a/v receiver without impairing the playback quality of the decoded music. Without proper shielding, acoustic artifacts can result which distract from the listening experience. With adequate shielding, the computer is able to provide a broad spectrum of additional content and supplemental information. Improved content includes stored audio and video materials, and supplemental information includes selection information detailing artist, recording and background particulars.

The claimed system and related device incorporates an improved audio/video receiver with enhanced electromagnetic shielding coupled with a personal computer with enhanced electromagnetic shielding. Electromagnetic shielding does not impair operation or performance, but it does substantially reduce the potential interference of either device by the operation of the other, as well as potential interference of video output devices such as monitors or projection televisions as well as interference of audio loudspeaker characteristics.

When properly shielded, both components benefit from the particular capabilities of the other. Home computer audio playback is nearly always by way of underpowered low quality computer speakers. The traditional home computer CPU and related hardware is often capable of the digital to analog conversion needed to decode and play music or audio content, but it is hardly optimized to do so. Internal interference from the computer power supply, video card and other components greatly impact the listener's experience. One of the more unfortunate recent developments is the additional audible noise generated by non-optimized, standard personal computers. As Moore's Law continues to hold true, increasing clock cycles lead to higher power consumption resulting in larger cooling fans. Related peripherals have also migrated from passive heat sinks to active fans cooling not only video cards but also memory boards. The net result is greatly increased sonic interference in addition to the electronic interference created by unshielded personal computers. Home audio/video receivers are specifically designed to avoid such problems, and as a consequence consistently provide a much more enjoyable audio experience. Higher end and midrange units often incorporate dedicated digital to analog converters which are optimized to perform better and more efficiently than general purpose CPU based devices adapted to the task. By shielding the computer and audio/video receiver components, positioning options also increase due to the lowered likelihood of video signal disruption from electromagnetic interference. Video output devices including Cathode Ray Tube (CRT) based models can show banding and visual distortion when positioned too closely to electromagnetic radiation sources which upset the x/y positioning of the electron gun which generates a picture on the picture tube.

With respect to quality audio and video input and output capabilities, standard personal computers are severely limited. Intensely competitive pricing has forced computer manufacturers to reduce component costs whenever possible. With the distinguishing sales emphasis on CPU speed or memory, component fittings for signal input and output are rarely upgraded in the process. Even standard audio/video receiver electrical fittings and low cost cable plugs are able to claim gold plating for enhanced electrical connectivity and improved audio experience while such upgrades are seldom found on personal computers. Redesigning the computer input and output from an audiophile perspective adds little to the overall cost while the intangible benefits to the music listening experience are substantial. When comparing operational characteristics of the two, at this point in time only the audio/video receiver has ‘appliance’ ease of operation with ‘pushbutton’ simplicity of control. Consequently, additional control buttons are integrated into the audio/video receiver to selectively control particular computer based functional elements. Examples by way of illustration but not of limitation include control buttons on the audio/video receiver or corresponding audio/video receiver remote control which when pressed will activate the personal computer to request content information from the Internet for display on the audio/video receiver display or connected monitor. Other examples include pushbutton access to stored video content when the computer has been acting with Personal Video Recorder (PVR) functionality, and pushbutton access to any personal computer based output content including real-time output of computer based audio and video signals. One embodiment of this pushbutton functionality would be during personal computer based computer gaming where the pushbutton functionality on the audio/video receiver routes video output content from the computer to the television screen and routes the corresponding computer gaming audio signal to the audio/video receiver for surround sound processing by the audio/video receiver with correspondingly higher audio fidelity.

A final benefit of the combination system includes the ability of Internet enabled personal computers to access remote music databases and download music specific related information. Commonly, audio compact disks do not easily provide track and artist information especially if the disk was manufactured more than two years ago. With the Internet link, the personal computer can send this information for display on the audio/video receiver in addition to audio and video content. This seemingly small benefit can result in a substantially better listening experience.

### BRIEF DESCRIPTION OF THE DRAWINGS

For a better understanding of the present invention, reference is made to the accompanying drawings numbered below. Commonly used reference numbers identify the same or equivalent parts of the claimed invention throughout the several figures.

FIG. 1 is a perspective view of the personal computer component of the claimed device and system.

FIG. 2 is a perspective view of the audio/video receiver component of the claimed device and system.

FIG. 3 is a back elevation view of the audio/video receiver component of the claimed device and system.

FIG. 4 is a back elevation view of the personal component of the claimed device and system.

FIG. 5 is a schematic representation of the claimed invention.

### MODES FOR CARRYING OUT THE INVENTION

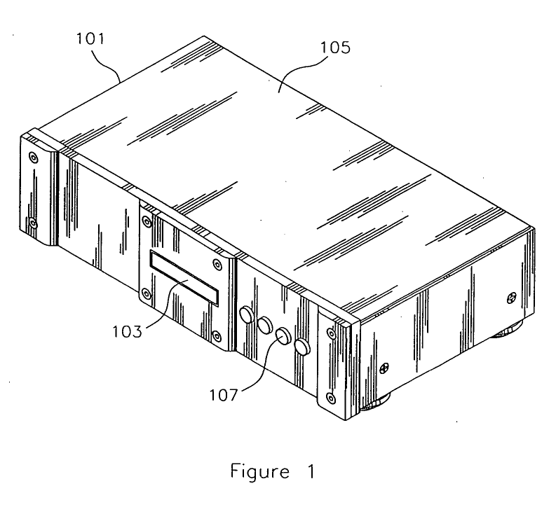

FIG. 1 is a perspective view of the personal computer component 101 of the claimed device system. In FIG. 1, the traditionally electronically and acoustically ‘noisy’ environment of the home computer 101 is shielded 105 to prevent noise artifacts from impairing audio and video playback by improved a/v receiver (not shown). Computer 101 is turned on by power button 107 and can alternately offer a ‘fast on’ variant which does not require the full boot-up process in order to provide basic content to the improved audio/video receiver (not shown). Stored media is read and written through DVD/CD drive 103.

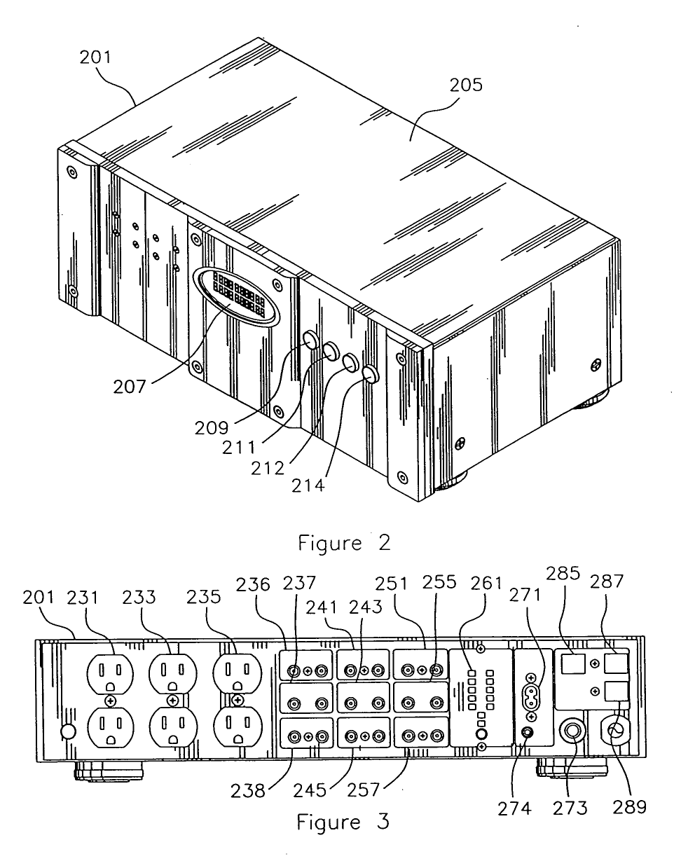

FIG. 2 is a perspective view of the audio/video receiver component 201 of the claimed device and system. The claimed system and related device incorporates an improved audio/video receiver 201 with enhanced electromagnetic shielding 205 coupled with an enhanced personal computer (not shown). Electromagnetic shielding 205 does not impair operation or performance, but it does substantially reduce the potential interference of either device by the operation of the other, as well as potential interference of video output devices such as monitors or projection televisions (not shown) as well as interference of audio loudspeaker characteristics. Device characteristics are reported by display 207 and the unit is activated once power button 209 has been pressed. Buttons 211, 212, 214 directly control functional processes on personal computer component (not shown) and can optionally have corresponding control buttons on a remote control device (not shown) as well. Functional processes include personal computer controlled routines which enhance the audio/visual media experience such as Internet access to retrieve media content information such as content title and artist information, streaming Internet radio and personal computer component (not shown) stored video content. It is expressly understood that such functionality is controlled by audio/video receiver component 201 and would not require additional personal computer interface interaction.

FIG. 3 is a back elevation view of audio/video receiver component 201 of the claimed device and system. Rear panel of receiver component 201 contains power outlets 231, 233, 235 for providing clean power to personal computer component (not shown) and peripheral devices (not show) such as a DVD player, television, satellite dish receiver or cable box. Rear panel 203 contains speaker cable ports 236, 237, 238, 241, 243, 245, component peripheral input and output ports 251, 255, 257, digital optical input and output ports 261, power cord socket 271 and antenna socket 274. Additional connectivity and interface options take place through expansion ports 273, 285, 287, 289 for optimized communication with personal computer component (not shown). Digital data needs to be passed from the personal computer (not shown) to audio/video receiver 201 without impairing the playback quality of the decoded music. Without proper shielding, acoustic artifacts can result which distract from the listening experience. With adequate shielding 203, the computer is able to provide a broad spectrum of additional content and supplemental information. Improved content includes stored audio and video materials, and supplemental information includes selection information detailing artist, recording and background particulars.

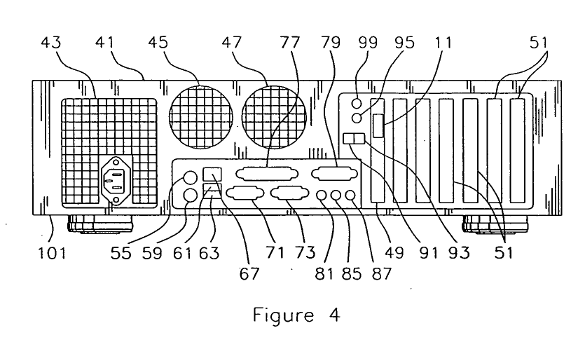

FIG. 4 is a back elevation view of the personal computer component 101 of the claimed device system. Personal computer 101 is protected from emitting electrical interference by shielding 41. Back elevation view of the personal computer component 101 also depicts power supply 43, cooling fans 45, 47, video port 49, add-on peripheral ports 51 (point to several PCI slot ports), keyboard port 59, mouse port 55, USB ports 61, 63, Ethernet port 67, Serial ports 71, 73, parallel port 77, DVI port 79, audio in port 81, audio out port 85, microphone port 87, optical in port 91, optical out port 93, coaxial cable in port 95, coaxial cable out port 99 and VGA port 11.

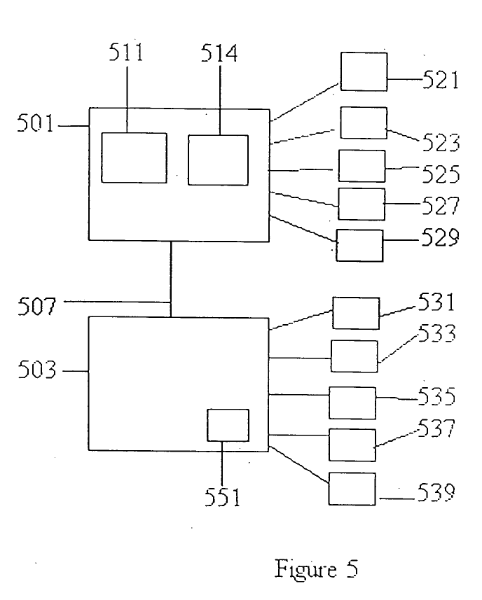

FIG. 5 is a schematic representation of the claimed invention by means of illustration but in no way by limitation. Optimized personal computer 501 is connected to enhanced audio/video receiver 503 by way of digital data connection 507. Optimized personal computer 501 receives data from DVD/CD writer 511 and stores content in hard drive 514. Data input sources include the Internet 521, cable television 523, broadcast television 525, telephone line 527 and wireless link 529. Enhanced audio/video receiver receives data from optimized personal computer 501 by way of digital data connection 507 or optionally by way of wireless data component 551. Wireless data transmission protocols include 802.11 variants, radio frequency and infrared (RF and IR) transmissions as well as others. Enhanced audio/video receiver 503 provides output to audio loudspeakers 531, DVD player 533, television monitor 535, cable television decoder 537 and VHS tape recorder 539.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference. And are intended to be encompassed by the present claims. Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, it should be readily apparent to those of ordinary skill in the art that various changes and modifications in form, apparatus material, and fabrication material detail may be made without departing from the spirit and scope of the inventions as set forth in the appended claims. No claim herein is to be construed under the provisions of 35 U.S.C. 112, sixth paragraph, unless the element is expressly recited using the phrase “means for.”

### INDUSTRIAL APPLICABILITY

The claimed invention has industrial applicability in the retail electronics marketplace. Moreover, the claimed invention also has industrial applicability in any environment where accurate representation of sound or music with computer enhanced media capabilities is desired.

I (we) claim:

1. An enhanced audio/video system comprising an audio/video receiver connected to an optimized personal computer.

2. The enhanced audio/video system of claim 1 wherein said optimized personal computer additionally comprises electromagnetic shielding.

3. The enhanced audio/video system of claim 1 wherein said audio/video receiver additionally comprises electromagnetic shielding.

4. The enhanced audio/video system of claim 2 wherein said audio/video receiver additionally comprises dedicated digital to analog circuitry for decoding media content obtained from said optimized personal computer.

5. The enhanced audio/video system of claim 4 wherein said personal computer contains a means for providing digital content upon request by the audio/video receiver.

6. The enhanced audio/video system of claim 5 wherein said personal computer contains a means for reducing audible sound generated by internal components.

7. The enhanced audio/video system of claim 6 wherein said audio/video receiver receives digital content by way of a wireless data pathway.

8. The enhanced audio/video system of claim 7 wherein said wireless data pathway is by way of an 802.11 protocol.

9. The enhanced audio/video system of claim 6 wherein said audio/video receiver contains control elements to control said personal computer through said audio/video receiver control elements.

10. The enhanced audio/video system of claim 9 wherein said control elements when pressed will activate the personal computer to request content information from the Internet for display on the audio/video receiver display or connected monitor.

11. The enhanced audio/video system of claim 9 wherein said control elements when pressed will access stored video content when the computer has been acting with Personal Video Recorder (PVR) functionality.

12. The enhanced audio/video system of claim 9 wherein said control elements route video output content from the computer to a television screen and routes the corresponding computer gaming audio signal to the audio/video receiver for surround sound processing by the audio/video receiver with correspondingly higher audio fidelity.

13. An enhanced audio/video system comprising an audio/video receiver connected to an optimized personal computer, said optimized personal computer additionally comprises electromagnetic shielding, said audio/video receiver additionally comprises electromagnetic shielding, said audio/video receiver additionally comprises dedicated digital to analog circuitry for decoding media content obtained from said optimized personal computer by way of a shielded and dedicated digital data pathway.

14. The enhanced audio/video system of claim 13 wherein said audio/video receiver contains control elements to control said personal computer through said audio/video receiver control elements.

15. The enhanced audio/video system of claim 13 wherein said control elements route video output content from the computer to a television screen and routes the corresponding computer gaming audio signal to the audio/video receiver for surround sound processing by the audio/video receiver with correspondingly higher audio fidelity.
